(19) United States
(12) Patent Application Publication
(10) Pub. No.: US 2022/0315326 A1
(43) Pub. Date: Oct. 6, 2022

(54) COLLECTION SYSTEM

(71) Applicant: Rainbow Bins LLC, Chicago, IL (US)

(72) Inventor: Ashley Devick Logan, Chicago, IL (US)

(21) Appl. No.: 17/221,951

(22) Filed: Apr. 5, 2021

(51) Int. Cl. B65F 1/00; B65F 1/06; B65F 1/16; B65F 1/14

(52) U.S. Cl. CPC B65F 1/004; B65F 1/06; B65F 1/16; B65F 1/1426; B65F 2250/105; B65F 2210/1123; B65F 2210/1128

(57) ABSTRACT

A collection system comprises a structure having a plurality of first openings that provide access to a plurality of separate volumes within the structure. Each separate volume of the plurality of separate volumes is associated with a scannable indicium of a plurality of scannable indicia, wherein the scannable indicium indicates a category of contents of the separate volume.

### FIELD OF THE INVENTION

The present invention relates generally to a collection system. In particular, the present invention relates to a collection system having separate volumes for collection of different categories of contents wherein the separate volumes are associated with scannable indicia identifying the categories.

### BACKGROUND OF THE INVENTION

The art of collecting refuse is a known and established technological market and municipal practice. Waste bins in public, private, domestic, or other shared living or occupational spaces are often used both to sort waste and collect it for transport to recycling centers or landfill stations.

Known collection centers have been placed on sidewalks, in airports, schools, offices, both single family and multi-family homes and condominiums, neighborhood activity centers, restaurants, coffee shops, cafes, gyms, cafeterias, malls, and the like, for collection of such known refuse types as aluminum cans, steel cans, aerosol cans, plastic clamshell packages, newspapers, glass containers, and other types of waste or refuse. Generally, this waste is collected by vehicle and sent to a sorting center or landfill, but instances of conveyance systems are known in some urban applications.

Sorting waste can contribute to increasing the amount of refuse that is recycled. Glass, metal, paper pulp, and other high value collectibles such as high density polyethylene (HDPE) are particularly valuable or otherwise coveted for purposes of recycling. If a sorting center can increase a concentration of these materials in their respective supply chain streams, a higher amount of such valuable types of refuse may be able to be recycled, while a lower amount of such valuable types of refuse may end up miscategorized, and undesirably sent to a landfill, ocean, lake, or other location.

A need exists for a collection system that allows for simple separation of refuse into multiple easily identifiable categories. It would be beneficial if such a collection system could be tagged or otherwise marked so that collection of the different identifiable categories of refuse could easily be tracked. It would be further beneficial if such a collection system could be made portable allowing for transport to gatherings, parties, concerts, and other sources of recyclable refuse.

### SUMMARY OF THE INVENTION

According to one aspect of the invention, a collection system comprises a structure having a plurality of first openings that provide access to a plurality of separate volumes within the structure. Each separate volume of the plurality of separate volumes is associated with a scannable indicium of a plurality of scannable indicia, wherein the scannable indicium indicates a category of contents of the separate volume.

According to another aspect of the invention, a collection system comprises a structure having a plurality of first openings that provide access to a plurality of separate volumes within the structure. A removable compost bucket is supported by the structure adjacent to one or more of the plurality of first openings.

According to a further aspect of the invention, a collection system comprises a portable structure having a rigid lid portion with a plurality of first openings disposed therethrough, a plurality of panels each flexibly connected along at least one edge thereof to at least one other panel, wherein the plurality of panels in a first configuration supports the rigid lid portion, and a flexible shroud that is supported by the rigid lid portion and disposed around a perimeter of the plurality of panels in the first configuration. The collection system further comprises a plurality of biodegradable bags, wherein each biodegradable bag of the plurality of biodegradable bags is supported at one first opening of the plurality of first openings.

### BRIEF DESCRIPTION OF THE DRAWINGS

The accompanying drawings which are incorporated in and which constitute a part of this specification illustrate exemplary constructions and procedures in accordance with the present disclosure, and, together with the general description of the disclosure given above, and the detailed description set forth below, serve to explain the principles of the disclosure wherein:

FIG. 1A illustrates a perspective view of an exemplary embodiment of a collection system of the present invention;

FIG. 1B illustrates a perspective view of another exemplary embodiment of a collection system of the present invention;

FIG. 10 illustrates a perspective view of a further exemplary embodiment of a collection system of the present invention;

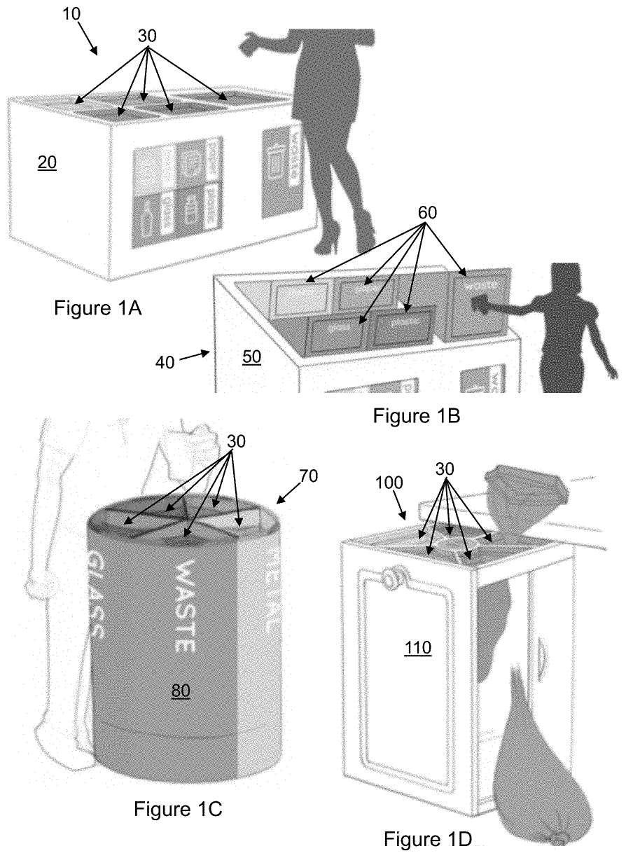

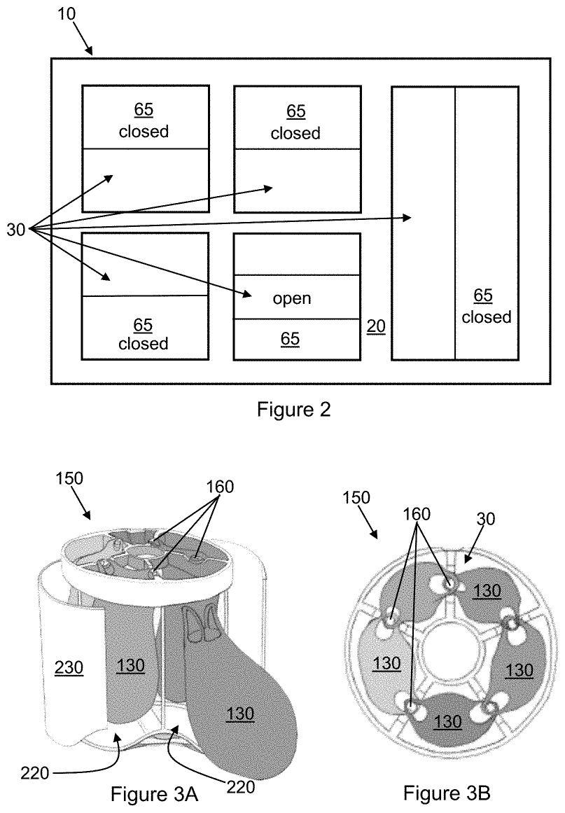

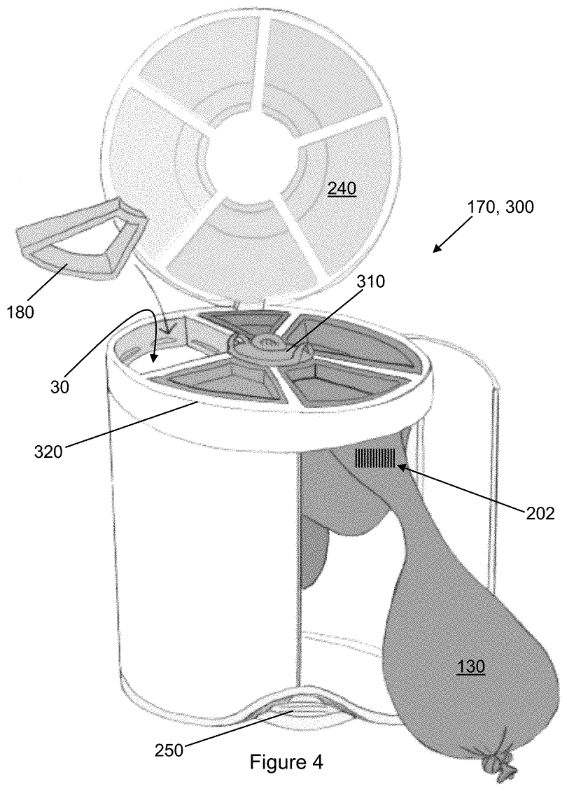

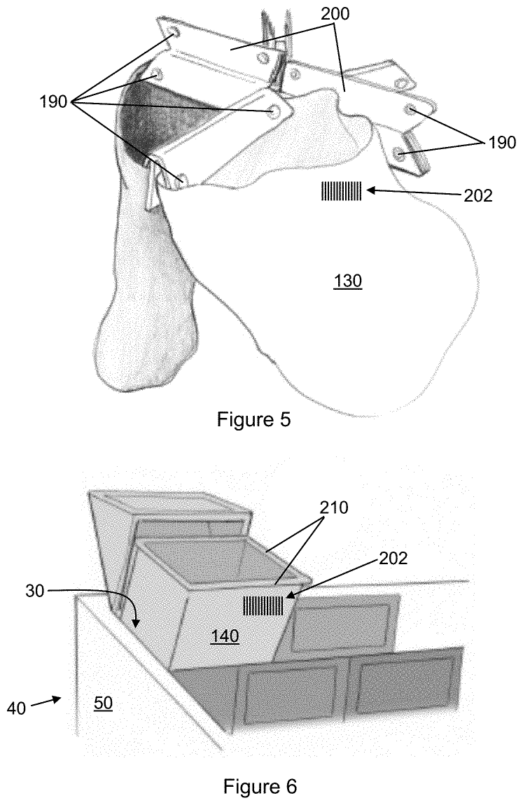

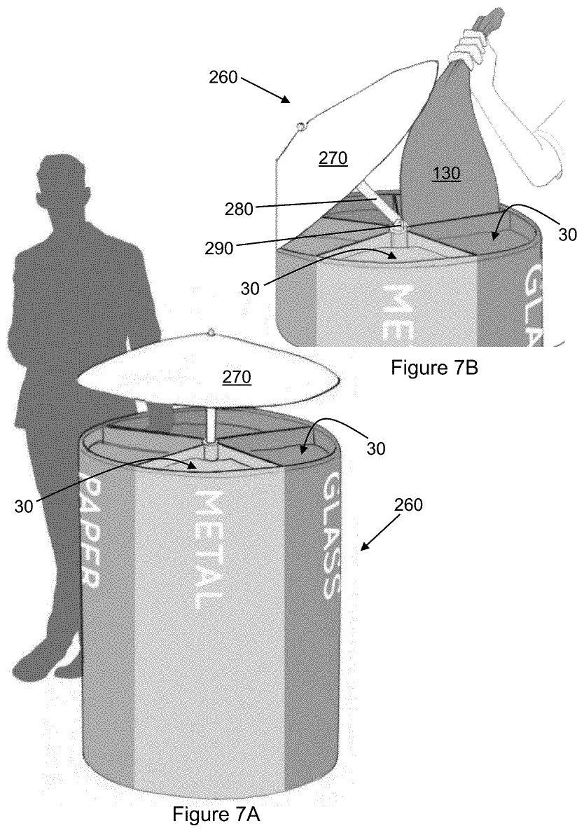

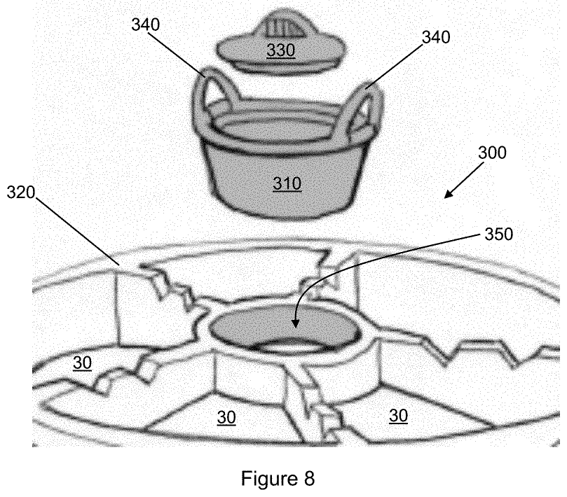

FIG. 1D illustrates a perspective view of yet another exemplary embodiment of a collection system of the present invention;

FIG. 2 illustrates a top plan view of the exemplary embodiment of the collection system of FIG. 1A;

FIG. 3A illustrates a perspective view of yet a further exemplary embodiment of a collection system of the present invention;

FIG. 3B illustrates a top plan view of the exemplary embodiment of the collection system of FIG. 3A;

FIG. 4 illustrates a perspective view of yet a further exemplary embodiment of a collection system of the present invention;

FIG. 5 illustrates an exemplary embodiment of flexible bags supported at edges of exemplary first openings;

FIG. 6 illustrates an exemplary embodiment of a rigid bin supported at edges of an exemplary first opening;

FIG. 7A illustrates a perspective view of yet another exemplary embodiment of a collection system of the present invention;

FIG. 7B illustrates a raised lid tilted toward one side of the exemplary embodiment of the collection system of FIG. 7A;

FIG. 8 illustrates an exemplary removable compost bucket supported by the structure of an exemplary embodiment of a collection system of the present invention;

FIG. 9A illustrates a perspective view of an exemplary embodiment of a portable collection system of the present invention;

FIG. 9B illustrates an exemplary rigid lid portion that is part of the exemplary embodiment of the portable collection system of FIG. 9A;

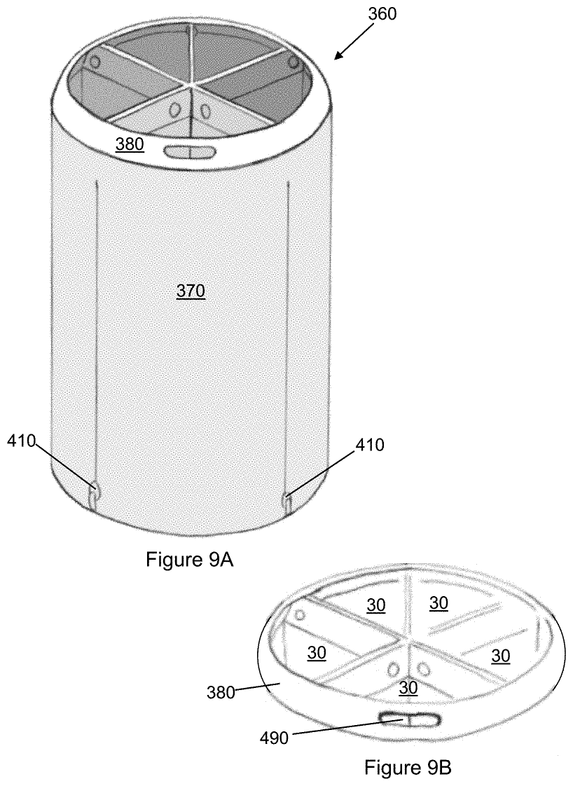

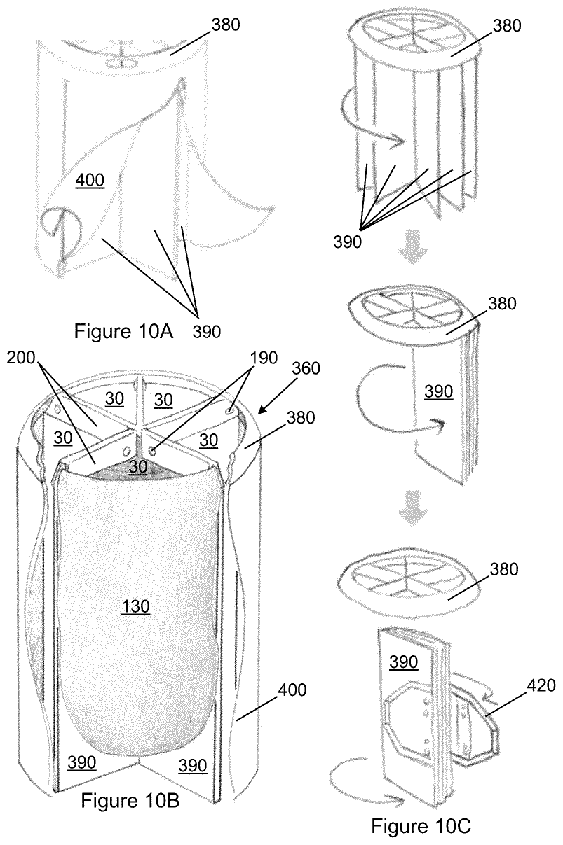

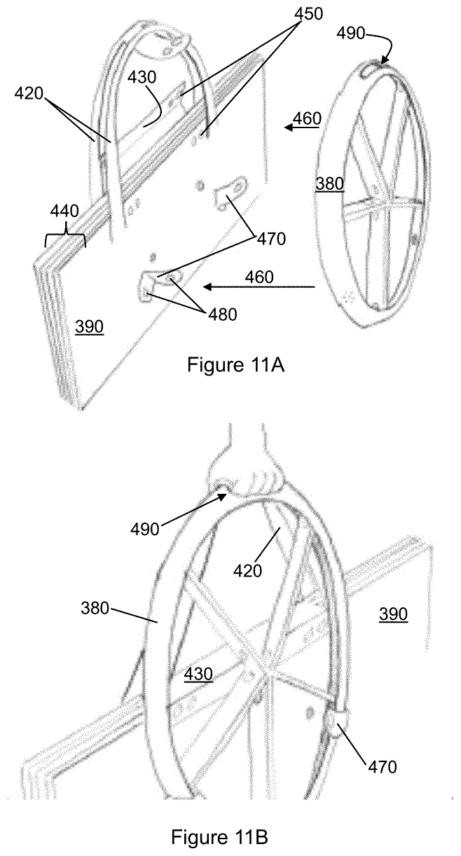

FIG. 10A illustrates an exemplary flexible shroud that is part of the exemplary embodiment of the portable collection system of FIG. 9A;

FIG. 10B illustrates exemplary internal structure of the exemplary embodiment of the portable collection system of FIG. 9A;

FIG. 10C illustrates steps in the transition of a plurality of panels of the portable collection system of FIG. 9A from a first configuration to a second configuration;

FIG. 11A illustrates the rigid lid portion and the plurality of panels of the portable collection system of FIG. 9A in the second configuration in process of being attached for portability; and

FIG. 11B illustrates the rigid lid portion and the plurality of panels of the portable collection system of FIG. 9A in the second configuration attached for portability.

When the disclosure has been illustrated and will hereinafter be described in connection with certain exemplary embodiments and practices, it is to be understood that in no event is the disclosure to be limited to such illustrated and described embodiments and practices. On the contrary, it is intended that the present disclosure shall extend to all alternatives and modifications as may embrace the general principles of this disclosure within the full and true spirit and scope thereof.

Other aspects and advantages of the present invention will become apparent upon consideration of the following detailed description, wherein similar structures have similar reference numerals.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Referring to FIGS. 1A-1D, several exemplary embodiments of the collection system of the current invention are illustrated. For example, the embodiment of a collection system 10 shown in FIG. 1A includes a structure or housing 20 having a plurality of first openings 30 through a flat top surface. The embodiment of a collection system 40 shown in FIG. 1B includes a somewhat different structure or housing 50 having an angled top surface that includes the plurality of first openings 30 (under lids 60). Another embodiment of a collection system 70 shown in FIG. 10 includes another structure or housing 80 having the plurality of first openings 30. A further embodiment of a collection system 100 shown in FIG. 1D includes a structure or housing 110 that may, for example, be a drawer that slides under a countertop. The structure 110 again includes the plurality of first openings 30.

In each of the embodiments of a collection system 10, 40, 70, 100 the plurality of first openings 30 provides access to a plurality of separate volumes within each of the respective structures 20, 50, 80, 110. Although FIGS. 1A-1D all show 5 first openings 30, the number of openings is not limited to 5 and other embodiments include a different number of openings as may be desired, for example, 2, 3, 4, 6, 7, 8, 9, 10, or more for sorting a different number of categories of refuse as will be described further hereinbelow.

Referring to FIG. 2, the collection system 10 is shown in a top plan view. Each of the separate volumes accessible within the structure 20 by the plurality of first openings 30 is associated with an indicium 32 of a plurality of indicia 32, where the indicium 32 is indicative of a category of contents of the separate volume. The indicia 32 can be associated with each of the separate volumes, for example, by being near an opening 30 or on a lid 65 covering an opening 30, or even on a bag 130 as shown in FIG. 4. For example, the plurality of indicia 32 in one embodiment is words 34 (see FIGS. 1A and 7A) indicative of the categories. As illustrated in the collection system 10 in FIG. 1A, for example, the categories are paper, plastic, metal, glass, and waste. In other embodiments the indicia 32 could be a combination of words 34 and colors 36 (see FIG. 7A, where the associated color for “METAL” could be for example yellow). In other examples, the indicia 32 can further comprise a representative image 38, for example, a bottle as shown in FIG. 1A. The indica 32 could also be mixed words 34, and/or colors 36, and/or symbols 38 where, for example, words 34 appear on a part of the structure 20, colors 36 appear on another part of the structure 20, and symbols 38 appear on yet another art of the structure 20.

In another embodiment the plurality of indicia 32 is a plurality of scannable indicia 202, for example, each in the form of a bar code, RFID tag, QR code, or other type of coded information 202 that can be visually scanned by an electronic scanner or other reader device as is known in the art.

The various embodiments of the collection system 10, 40, 70, 100 and other embodiments to be further described hereinbelow all further include a plurality of containers 120 that are each supported at one of the first openings 30. The plurality of containers 120 define the bounds of each of the separate volumes accessible through the plurality of first openings 30. In one embodiment the plurality of containers 120 comprises flexible preferably biodegradable bags 130. In another embodiment the plurality of containers comprises rigid bins 140. In a further embodiment the plurality of containers 120 comprises flexible preferably biodegradable bags 130 inside of rigid bins 140.

In one embodiment each container of the plurality of containers 120 is marked with the indicium 32, 202 associated with the separate volume defined by the container. In another embodiment each container of the plurality of containers 120 is marked with a scannable indicium 202 associated with the separate volume defined by the container. As noted above, scannable indicia 202 can be, for example, in the form of a bar code, RFID tag, QR code, or other type of coded information 202 that can be visually scanned by an electronic scanner or other reader device as is known in the art. For example, without limitation, a flexible bag 130 is marked with a bar code indicium 202 in FIGS. 4 and 5, and a rigid bin 140 is marked with the bar code indicium 202 in FIG. 6.

There are several ways in which the bags 130 or the bins 140 can be supported at one of the first openings 30. For example, FIGS. 3A and 3B illustrate an embodiment of a collection system 150 having flexible bags 130 as the containers 120. Each of the flexible bags 130 in this embodiment has two handles at an open end of the bag. Edges of the first openings 30 include upwardly extending protrusions or fingers 160. At least one handle on each bag 130 loops over at least one protrusion 160 to support each of the bags 130. Preferably both handles loop over the protrusions 160 on opposite edges of each of the first openings 30 as shown in FIG. 3A.

In another embodiment of a collection system 170 as shown in FIG. 4, for example, bags 130 are supported by collars 180 that press fit into the openings 30. In this embodiment open ends of a bag 130 are brought through the inside of the collar 180 and folded over the outside of the collar 180 so that when the collar 180 is press fit into a first opening 30 compression of the press-fit holds the open ends of the bag 130 between the collar 180 and edges of the first opening 30.

In a further embodiment, for example as could also be shown by the collection system 170 of FIG. 4, each bag 130 is part of a continuous bag sheet or elongate tube of bag material that is stored within an internal volume of a collar 180. A free end of the bag sheet is pulled out of the volume and around the outside of the collar 180 to a desired length before being tied off by a knot 135. The collar 180 can then be press fit into a first opening 30 as described above, where the press fit prevents further bag material from being pulled out of the collar 180. When the particular bag 130 is filled or otherwise needs to be changed, the bag can 130 can be torn off or otherwise be cut off by a blade or other implement above the knot. The portion that is torn off can be disposed of and additional bag material of a desired length can be pulled out of the volume of the collar 180 and tied with a new knot at the desired length. Such a knotted bag 130 allows a user to use only a length of bag material as needed, which saves on bags.

Referring to FIG. 5 in another embodiment the bags 130 are supported at the first openings 30 by snaps 190. For example in this embodiment a flap of material 200 extends from at least one edge of each of the first openings 30. Each flap 200 has at least one male or female side of a snap button disposed on it and oriented to snap connect with a cooperating female or male snap button disposed on the edge of the first opening 30 from which the flap 200 extends. The open ends of the bags 130 are captured between the snaps on at least one edge of each of the first openings 30, and preferably on two opposite edges of each of the first openings 30.

Referring to FIG. 6, an embodiment wherein the containers 120 are rigid bins 140 is shown. In this embodiment an open end of each bin 140 has at least one rigid shoulder 210 that is supported by an edge of the one first opening 30. Preferably the rigid shoulder 210 is present on two opposite open edges of the rigid bin 140.

As is apparent from FIGS. 3B and 6, regardless of the type of container 120 in a particular embodiment the plurality of containers 120 is removable from the structure or housing (e.g., 20, 50, 80, 110) through the plurality of first openings 30. In some embodiments the structure or housing (e.g., 20, 50, 80, 110) further comprises a plurality of second openings 220, and in these embodiments the plurality of containers 120 is removable from the structure or housing (e.g., 20, 50, 80, 110) through the plurality of second openings 220. For example, referring to FIG. 3A, an embodiment of a structure or housing 230 includes sides that open to allow access for removal of the plurality of containers 120 (in this embodiment flexible bags 130) disposed therein.

The various embodiments of the collection system 10, 40, 70, 100 and other embodiments to be further described hereinbelow can all further include at least one lid covering at least one of the plurality of first openings 30. For example, FIG. 1B shows a plurality of hinged lids 60 covering the plurality of first openings 30 (which are not visible in FIG. 1B because they are covered by the lids 60). FIG. 2 illustrates a plurality of inwardly opening two-sided spring loaded lids 65 as are known in the art, where a central line between the two closed halves of each closed lid is visible, and one lid is illustrated in an open position.

Alternatively, FIG. 4 illustrates a single lid 240 in an open position. In the embodiment of FIG. 4, the lid 240 is hinged and controlled by a foot pedal 250 via intermediate control linkages as is known in the art. In other embodiments, a lid may be hinged or entirely removable and can cover only a single or multiple first openings 30 as is desired and known in the art.

In another embodiment of a collection system 260 shown in FIGS. 7A and 7B, a raised lid 270 is disposed over the plurality of first openings 30 while allowing access to the openings 30. Such a lid 270 could be especially useful in an outdoor venue to keep rain out of the collection system 260 while still allowing the public free access to drop in refuse. As shown in FIG. 7B, the lid 270 in this embodiment further includes a tiltable supporting rod 280 that includes a rotatable joint 290 as is known in the art to allow the lid 270 to be tilted toward one side of the collection system 260 for allowing easier access to the plurality of first openings 30 on an opposite side of the collection system 260.

Referring to FIGS. 4 and 8, in some embodiments a collection system 300 includes a removable compost bucket 310 that is supported by the structure or housing 320 adjacent to one or more of the plurality of first openings 30. Referring to FIG. 8 for example, the compost bucket 310 has a removable lid 330 and handles 340 for easier lifting out from the collection system 300. In this embodiment the compost bucket 310, for example, has tapered side walls and is supported by a central opening 350 having a diameter larger than the bottom diameter of the compost bucket but not larger than the largest diameter of the compost bucket 310 so that the compost bucket 310 nests within the central opening 350. In other embodiments the compost bucket is supported by the structure 320 by being disposed in a shallow recess or on a flat surface or in any suitable way as may be known in the art.

Referring to FIGS. 9A and 9B, in another embodiment a collection system 360 comprises a portable structure or housing 370 that breaks down and can be folded up for easy carrying. The portable structure 370 includes a rigid lid portion 380 shown separately in FIG. 9B and having a plurality of first openings 30 disposed therethrough.

Referring to FIGS. 10A-10C, the portable structure 370 further includes a plurality of panels 390 that have a first configuration and a second configuration. Each panel of the plurality of panels 390 is flexibly connected along at least one edge thereof to at least one other panel. In one embodiment the plurality of panels 390 are all connected so that in a first or unfolded configuration the panels 390 form a star shape matching a shape of the edges of the first openings 30 in the rigid lid portion 380. In fact, in a first configuration the plurality of panels 390 supports the rigid lid portion 380 as shown in FIGS. 10A and 10B.

For example in one embodiment a bottom side of the edges of the first openings 30 comprises a groove or recess that accommodates a top edge of each of the plurality of panels 390. In another embodiment a flap of material 200 extends from at least one edge of each of the first openings 30, for example as shown in FIG. 10B, the flap 200 having one or more snap connectors 190 thereon (as also described hereinabove with regard to FIG. 5). In this embodiment the top edges of the plurality of panels 390 can be accommodated in the spaces between the flaps 200 and the edges of the first openings 30 from which the flaps 200 extend (see FIG. 5). Referring to FIG. 10B, the embodiment of the collection system 360 further includes a plurality of flexible preferably biodegradable bags 130, wherein each bag 130 is supported at one first opening of the plurality of first openings 30, for example, by the snaps 190 as already described hereinabove with regard to FIG. 5.

Referring to FIGS. 10A and 10B, a flexible shroud 400 is supported by the rigid lid portion 380. In one embodiment the flexible shroud 400 is disposed around a perimeter of the plurality of panels 390 in the first configuration. The flexible shroud 400 can be supported by a bead on a top end that engages with a recess disposed around the rigid lid portion 380, by having a top end that is slightly smaller in diameter than a bottom end so that the flexible shroud 400 can slide down over the rigid lid portion 380, or by any other way of support as is suitable or otherwise known in the art. The shroud 400 in one embodiment includes one or more zippers 410 (see FIG. 9A) that allow the shroud 400 to be zipped open as shown in FIG. 10A. Opening the zippers 410 also provides for a plurality of second openings 220 as described for other embodiments hereinabove.

Referring to FIG. 100, the plurality of panels 390 transitions from a first configuration as shown for example in FIGS. 10A and 10B to a second configuration for example as shown in the bottom image in FIG. 100. The transition from the first configuration to the second configuration requires that the plurality of panels 390 folds up from a star shape to a stack of panels 390 representative of the plurality of panels 390 in the second configuration. In one embodiment the flexible shroud 400 is also adapted to be folded up and tucked between two adjacent panels 390 of the stack of panels 390 in the second configuration.

A benefit of being able to fold up the plurality of panels 390 is that by doing so the collection system 360 can be made portable. An aid to the portability is that as shown in FIGS. 10C and 11A the outermost panel on at least one side of the stack of panels 390 in the second configuration includes a handle strap 420 extending therefrom.

A further aid to the portability is that as shown in FIG. 11A the outermost panel on a first side of the stack of panels 390 in the second configuration includes at least one first strap or fastener 430 that folds over at least one edge 440 of the stack of panels 390 in the second configuration and attaches to the outermost panel on a second side of the stack of panels 390 to secure the stack of panels 390 in the second configuration. The at least one first fastener 430 may fasten, for example, via snap connectors 450 as shown, by latches, by a belt/loop type connection, or by other known connection mechanisms as may be known in the art.

The rigid lid portion 380 can also be secured to the stack of panels 390 in the second configuration as illustrated in FIGS. 11A and 11B by arrows 460. The outermost panel on one side of the stack of panels 390 in the second configuration includes at least one second fastener 470 adapted to secure the rigid lid portion 380 to the one side of the stack of panels 390 in the second configuration. The at least one second fastener 470 in one embodiment is a loop or strap of material that extends from the one side of the stack of panels 390, can be placed around a part of the rigid lid portion 380, and can be securely fastened to itself and/or to the one side of the stack of panels 390. The at least one second fastener 470 may fasten, for example, via snap connectors 480 as shown, by latches, by a belt/loop type connection, or by other known connection mechanisms as may be known in the art.

Referring again to FIG. 11A, the rigid lid portion 380 has a handle hole 490 disposed therethrough (see also FIG. 9B). when the rigid lid portion 380 is secured to the one side of the stack of panels 390 in the second configuration as shown in FIG. 11B, the handle hole 490 aligns with the at least one handle strap 420 for carrying the portable structure 370 with the stack of panels 390 in the second configuration.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### INDUSTRIAL APPLICABILITY

The collection system can be used for collecting waste and recyclable materials in various environments, such as municipal spaces or private or commercial interiors. The collection system can be manufactured, made, or used in industry for use by consumer.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

1. A collection system, comprising:
a structure having a plurality of first openings that provide access to a plurality of separate volumes within the structure; wherein
each separate volume of the plurality of separate volumes is associated with a scannable indicium of a plurality of scannable indicia, wherein the scannable indicium indicates a category of contents of the separate volume.

2. The collection system of claim 1, further comprising:
a plurality of containers selected from the group of containers consisting of biodegradable bags and rigid bins; wherein
each container of the plurality of containers is supported at one first opening of the plurality of first openings; and wherein
each separate volume is defined by one of the plurality of containers.

3. The collection system of claim 2, wherein each container of the plurality of containers is marked with the scannable indicium associated with the separate volume defined by the container.

4. The collection system of claim 2, wherein the plurality of containers is removable from the structure through the plurality of first openings.

5. The collection system of claim 2, wherein the structure further comprises a plurality of second openings, and wherein the plurality of containers is removable from the structure through the plurality of second openings.

6. The collection system of claim 2, further comprising at least one lid covering at least one of the plurality of first openings.

7. The collection system of claim 2, wherein each container of the plurality of containers is supported at one first opening of the plurality of first openings by a support mechanism selected from the group of support mechanisms consisting of: snaps, at least one rigid shoulder on the container supported by an edge of the one first opening, a collar that press-fits into the one first opening and holds a portion of the container between the collar and the one first opening, or at least one handle on the container that loops over at least one protrusion disposed on an edge of the one first opening.

8. The collection system of claim 1, wherein the scannable indicium is a barcode.

9. The collection system of claim 1, wherein the category of contents is selected from the categories consisting of glass, plastic, paper, metals, and waste.

10. A collection system, comprising:
a structure having a plurality of first openings that provide access to a plurality of separate volumes within the structure; wherein
a removable compost bucket is supported by the structure adjacent to one or more of the plurality of first openings.

11. The collection system of claim 10, further comprising:
a plurality of containers selected from the group of containers consisting of biodegradable bags and rigid bins; wherein
each container of the plurality of containers is supported at one first opening of the plurality of first openings; and wherein
each separate volume of the plurality of separate volumes is defined by one of the plurality of containers.

12. The collection system of claim 11, wherein the plurality of containers is removable from the structure through the plurality of first openings.

13. The collection system of claim 11, wherein the structure further comprises a plurality of second openings, and wherein the plurality of containers is removable from the structure through the plurality of second openings.

14. The collection system of claim 11, further comprising at least one lid covering at least one of the plurality of first openings.

15. The collection system of claim 11, wherein each container of the plurality of containers is supported at one first opening of the plurality of first openings by a support mechanism selected from the group of support mechanisms consisting of: snaps, at least one rigid shoulder on the container supported by an edge of the one first opening, a collar that press-fits into the one first opening and holds a portion of the container between the collar and the one first opening, or at least one handle on the container that loops over at least one protrusion disposed on an edge of the one first opening.

16. A collection system, comprising:
a portable structure comprising:
a rigid lid portion having a plurality of first openings disposed therethrough;
a plurality of panels each panel flexibly connected along at least one edge thereof to at least one other panel, wherein the plurality of panels in a first configuration supports the rigid lid portion; and
a flexible shroud that is supported by the rigid lid portion and disposed around a perimeter of the plurality of panels in the first configuration; and
a plurality of biodegradable bags, wherein each biodegradable bag of the plurality of biodegradable bags is supported at one first opening of the plurality of first openings.

17. The collection system of claim 16, wherein:
the plurality of panels has a second configuration wherein the plurality of panels folds up into a stack of panels; and wherein
the flexible shroud is adapted to be folded up and tucked between two adjacent panels of the stack of panels representative of the plurality of panels in the second configuration.

18. The collection system of claim 17, wherein:
the outermost panel on at least one side of the stack of panels in the second configuration includes a handle strap extending therefrom; and
the outermost panel on a first side of the stack of panels in the second configuration includes at least one first fastener that folds over at least one edge of the stack of panels and attaches to the outermost panel on a second side of the stack of panels in the second configuration to secure the stack of panels in the second configuration.

19. The collection system of claim 18, wherein the outermost panel on one side of the stack of panels in the second configuration includes at least one second fastener adapted to secure the rigid lid portion to the one side of the stack of panels in the second configuration.

20. The collection system of claim 19, wherein the rigid lid portion has a handle hole disposed therethrough so that when secured to the one side of the stack of panels in the second configuration the handle hole aligns with the handle strap for carrying the portable structure with the stack of panels in the second configuration.
